(19) United States
(12) Patent Application Publication
(10) Pub. No.: US 2004/0189641 A1
(43) Pub. Date: Sep. 30, 2004

(54) Method and apparatus for determining intersections of a particular line with cells in a lattice

(76) Inventors: Peter Stephenson, Providence, RI (US); Bruce Litow, Kirwan (AU)

Correspondence Address: GORDON E NELSON, PATENT ATTORNEY, PC, 57 CENTRAL ST, PO BOX 782, ROWLEY, MA, 01969, US

(21) Appl. No.: 10/485,886

(22) PCT Filed: Aug. 2, 2002
(86) PCT No.: PCT/US02/24711

Related U.S. Application Data
(60) Provisional application No. 60/309,926, filed on Aug. 3, 2001.

(51) Int. Cl. G06T 11/20

(52) U.S. Cl. 345/443

(57) ABSTRACT

Disclosed are techniques for determining in a lattice a set of cells of the lattice that are intersected by a line endpoints. The tech-niques employ orders 1 . . . n of runs of lattice cells to make the determination and are usable with lines whose endpoints have coordinates that may be any real number. The techniques include an initialization that derives an error term with a real number value and a structural parameter with a real number value for order 1 using the values of the coordinates of the end points and then determines the error terms and structural parameters for each order i belonging to the orders 2 . . . n using the error term and structural parameter for order i−1. When the first run of any orders 1 . . . n is truncated, the initialization also adds the cells belonging to the truncated run to the set. When the initialization is finished, the remaining cells belonging to the set are determined using full runs of order n. In either the initialization or the determination using full runs, the techniques terminate when a cell is added to the set that includes the x and y coordinates of the line's end-points. Also included is a technique for determining whether the cell that includes the x and y coordinates of the start of the line is to be included in the set of cells prior to the initialization. When the cell is so included, the relationship between the x and y coordinates of the start of the line and the x and y coordinates of the lower left-hand comer of the cell are used together with the slope of the line to obtain an error term which is used to determine the location of the next cell belonging to the set. Disclosed applications of the technique include making pixel representations of lines and determining locations in a plane that is represented by a lattice that are intersected by particular lines.

### CROSS REFERENCES TO RELATED APPLICATIONS

The present patent application claims priority from U.S. provisional patent application 60/309,926, Stephenson, et al., Process and apparatus for line drawing, filed 3 Aug. 2001.

### BACKGROUND OF THE INVENTION

1. Field of the Invention

The invention relates generally to techniques for determining which cells of a raster are intersected by a particular line. The cells of the raster are represented in the memory of a computer system and the determination is made by the computer system's processor. The cells of the raster may generally represent a set of locations. The locations may be pixels in a display, and when they are, the techniques may be used to determine which pixels in the display represent the particular line, and thus to generate the line in the display.

2. Description of Related Art

FIGS. 9-11

Systems Using Raster Display Devices: FIG. 9

The flat panel or cathode ray tube display devices typically used with computer systems are raster devices, that is, the display area is made up of a large number of picture elements, or pixels, which are arranged in a grid. The location of any pixel in the display can be specified by its row and column in the grid. The image that the display device displays is made by varying the color and intensity of the pixels in the grid.

FIG. 9 is a high-level overview of a computer system with a raster display device. The main components of system 901 are a processor 911 with memory 903 to which processor 903 has access and a monitor 915 for which processor 911 generates displays. Monitor 915 is a raster display device and as such, has a grid of pixels 917. Within memory 903 are stored bitmap 909, bitmap drawing code 985, and bitmap data 907. Bitmap 909 is an area of memory that corresponds to grid of pixels 917. Each item of data in bitmap 909 corresponds to a pixel in grid of pixels 917. Drawing code 985 is code for drawing graphical entities such as lines or polygons in bitnap 909. Bitmap data 907, finally, is data, typically supplied by a user program, which bitmap drawing code 985 uses to draw a graphical entity. For example, if a user program wishes to specify a line, it will typically indicate the start and end coordinates of the line in grid of pixels 917 and drawing code 985 will use that information to draw a corresponding line in bitmap 909. Processor 911 then reads from bitmap 909 to generate an image for display on grid of pixels 917. In many cases, a display generator component 913 of processor 911 reads bitmap 909 and produces the actual signals for monitor 915 from the data in bitmap 909. It should be noted here that the task of producing a display 917 may be distributed in many different ways across hardware and software components, with the amount of hardware increasing as performance demands increase.

Representing Lines Using Pixels: FIG. 10

Drawing straight lines is a problem with any raster display device. FIG. 10 shows why. FIG. 10 shows a representation in pixels 1001 of the line 1003 that is described by the equation

$$y = \frac{17}{41} x .$$

The representation includes those pixels in the grid which are intersected by line 1003. These pixels form a pattern 1004 which is termed the intersection pattern for the line. A line's intersection pattern depends not only on the line's slope, but also on the location of its endpoints relative to the grid of pixels. As will be explained in more detail in the following, the intersection pattern for any straight line has regular features that can be used in drawing the straight line in a raster display or analyzing a straight line that is displayed in a raster display.

At its lowest level, the intersection pattern for line 1003 is a sequence of pixels. For a given next pixel, there are only two possibilities: if the current pixel has the coordinates (a,b), the next pixel has either the coordinates (a+1,b) or (a+1,b+1). Which of the two possibilities the next pixel has depends on where the line intersects the current pixel. To draw a line one pixel at a time, one need only determine for each pixel where the line intersects the current pixel and use that information to determine which of the two possible positions to give the next pixel.

As is apparent from FIG. 10, the intersection pattern includes groups of adjacent pixels that have the same y coordinate. Such a group of pixels is called a run. One such run of three pixels is shown at 1005. An examination of the runs in FIG. 10 shows that they have only two lengths: a short length 107, which is here two pixels, and a long length 1009, which is here three pixels. The general rule is that the runs of an intersection pattern will have only two lengths, and these lengths will be consecutive integers. The lengths of the long and short runs for any given line can be computed as follows:

Within the intersection pattern of the line

$$l \text{:} y = \frac{a}{d} x ,$$

there are a runs that correspond to the Y-axis size of the lattice. As there are only two possible run lengths in a given intersection pattern and the possible lengths are consecutive integers we will refer to the lengths as short (s) and long (l). To determine what run lengths are possible within the intersection pattern, consider that there are d pixels to be distributed among a runs, the distribution being as even as possible. If we divide up the d pixels into a runs of length

$$r = ⌊ \frac{d}{a} ⌋$$

we have n≡d mod a pixels remaining, 0≦n<a, which have to be distributed along the intersection pattern. Therefore in the intersection pattern of l there are n long runs each with r+1 pixels and a−n short runs with r pixels each.

This can be applied to line 1003 as follows: line 1003 contains 41 pixels and 17 runs. The possible run lengths are

$$r = ⌊ \frac{41}{17} ⌋ = 2$$

and r+1=3. There are 41 mod 17≡7 long runs 1009 of length three shown in light gray and 17-7=10 short runs 1007 of length two shown in dark gray. Therefore using a run-based algorithm improves upon pixel-based algorithms as only a and not d decisions whether to increase the y coordinate by 1 are necessary.

An examination of intersection pattern 1004 of line 1003 shows that the long and short runs themselves occur in repeating patterns. Thus, in intersection pattern 1004, there is a repeating pattern of a long run (l) followed by two short runs (s) followed by a long run followed by one short run, or lssls, as shown at 1011 and 1013. In general, there are four possibilities for the patterns of runs:

ls⁺, a long run followed by one or more short runs;

l⁺s, one or more long runs followed by a short run;

sl⁺, a short run followed by one or more long runs; and

s⁺l, one or more short runs followed by a long run.

These patterns are termed in the following the shapes of runs. Thus, using this notation, the shape of the runs shown at 1011 and 1013 is ls⁺. Moreover, it turns out that the first run in the intersection pattern of the line

$$l \text{:} y = \frac{a}{d} x$$

must be long. Therefore we need only two shapes: ls⁺ and l⁺s to describe the intersection patterns of a line. ls⁺ applies when there are more short runs than long runs in the intersection pattern and l⁺s when there are more long runs than short. In the case where there are equal numbers of runs, the two cases are equivalent.

The properties just described also apply to runs of runs. For example in intersection pattern 1004, the complete sequence of runs is lslslsslslsslslss; therefore we have singularly occurring runs l separating sequences of shorts runs s⁺ and the intersection pattern is constructed of runs of runs with the shape ls⁺. The terminology of runs of runs is cumbersome so let us define these runs of runs to be second order runs. Where a run is defined by its position and length, a second order run is defined by its position, its length is defined by the number of runs which comprise it, and its shape is determined by whether there are more long or short runs in the pattern. By analogy with second order runs, we can define runs to be first order runs and pixels to be zero order runs.

To determine the possible lengths of the second order runs let us consider the case where there are more short runs than long and continue the use of our example. In this case, the number of second order runs must be the same as the number of long runs in the pattern by definition. If there are n long runs in the line there are a runs to divide amongst n second order runs. Therefore if the division is to be as even as possible the length of a short second order run, r^{[2]}, will be

$${r}^{[ 2 ]} = ⌊ \frac{a}{n} ⌋ .$$

There will be n^{[2]}≡a mod n long runs and a−n^{[2]} short runs of order 2. The second order runs appear at 1011 and 1013 in intersection pattern 1004. There are more short runs 1013 than long, so the second order runs have the shape ls⁺, i.e., one long run followed by a sequence of short runs. There are three long runs 1011 of length three and four short runs 1013 of length two.

There is no reason to end this hierarchical description at order 2. We can define a recursive hierarchical description of the intersection pattern of the line l based on defining runs of higher order. For orders three and above, there is no restriction that the first run in the intersection pattern must be long and therefore all four possible shapes can occur. For order i, if there are more short runs of order i−1 in the intersection pattern, the shape of the order i runs will be s⁺l or ls⁺. If there are more long runs of order i−1, the shape will be l⁺s or ls⁺. An example of third order runs in the intersection pattern 1004 is shown at 1015 and 1017. There are three runs of order 3 amongst which the seven runs of order 2 are to be distributed as evenly as possible. Therefore the length of a short run of order 3 is

$${r}^{[ 3 ]} = ⌊ \frac{7}{3} ⌋ = 2 ,$$

and amongst the three order 3 runs, there will be 7 mod 3≡1 long run of length r^{[3]}+1=3. The shape of the order 3 runs is s⁺l. For lines with a rational slope, the hierarchical description of ordered runs within the intersection pattern will be bounded, as the intersection pattern is eventually repeated if a and d are not coprime.

For the example line 1003

$$l \text{:} y = \frac{17}{41} x ,$$

the process reaches its conclusion at order 4. There are three order 3 runs, of which one is long and two are short. There will be therefore one order 4 run containing all three order 3 runs and starting with the only long order 3 run. The order 4 run is the entire intersection pattern of the line

$$l \text{:} y = \frac{17}{41} x$$

and the lattice L_{(41,17).}

Dealing with Lines which do not Intersect the Origin: FIG. 11

Introducing a non-zero intercept to a line with rational slope presents a number of complications. Consider the line

$$l \text{:} y = \frac{a}{d} x + β$$

where a and d are coprime. Within the frame of the lattice L_{(d,a),} the line y forms an intersection pattern that is repeated throughout the infinite intersection pattern defined upon the unbounded lattice. Therefore we will only consider the intersection pattern pₗ within the frame L_{(d,a).}

Let us consider first the line

$$l \text{:} y = \frac{a}{d} x + β$$

where β=0. Within the frame L_{(d,a),} the vertical distance the line l is above any lattice point within the intersection pattern is

$$\frac{{b}_{j}^{[ 0 ]}}{d}$$

where bⱼ^{[0]}=0, . . . , d−1 where the values bⱼ^{[0]} are those values of the order 0 numerator sequence. The numerator sequence is a sequence of the numerators of the fractions

$$\frac{{b}_{j}^{[ 0 ]}}{d} .$$

These fractions specify the point in the left edge of the pixel at which the line intersects the pixel. Therefore the line is at least

$$\frac{1}{d}$$

from any lattice point. If the value of β is raised slowly, the intersection pattern will remain unchanged until the line crosses or intersects a lattice point. Therefore the first change will occur when

$$β = \frac{1}{d} .$$

Let the lattice point intersected be (xₕ,yₕ).

As the line

$${l}^{′} \text{:} y = \frac{a}{d} x + β$$

intersects the point (xₕ,yₕ) and the line

$$l \text{:} y = \frac{a}{d} x$$

intersects the origin, the intersection pattern p_{l′} of the line l′ will be identical to the intersection pattern pₗ of the line l translated by (xₕ,yₕ). Therefore the introduction of an intercept to a line with rational slope will, more often than not, cause a shifting of the intersection pattern of the line. The key values of the intercept at which this translation of the intersection pattern occurs are

$$β = \frac{1}{d}$$

where b=0, . . . , d−1.

FIG. 11 gives an example. At 1001, the figure shows the intersection pattern of the line

$$l \text{:} y = \frac{17}{41} x .$$

At 1101, the figure shows the effect of introducing an intercept value of

$$\frac{23}{41}$$

on the interception pattern. The numerator sequence for order 0 of 1001 is shown at 1109 and that for order 0 of 1101 at 1111.

Given that the numerator of the intercept is b=23, we have demarcated the pixels before (1103) and after (1104) b=23 in order 0 numerator sequence 1109 by a dashed line 1102. The pixels 1104 to the right of this value are denoted by light gray and the pixels 1103 to the left by dark gray. At 1101, we can see that adding the intercept value

$$\frac{23}{41}$$

shifts the light gray pixels 1104 to the beginning of the intersection pattern, pᵣ The dark gray pixels 1103 now form the end of the pattern pᵣ Coinciding with the shift in pixels, the values of numerator sequence of order 0 1111 are also shifted and now start with a value of b₀^{[0]}=b=23. The shifting of the runs of all orders in the intersection pattern with the introduction of a non-zero intercept is mimicked by the shift in the values of the numerator sequence.

The shifting of the intersection pattern due to the introduction of a non-zero intercept has a number of side effects. The initial and final run of any order may be truncated. This occurs when the numerator of the intercept is not in the numerator sequence of that order. A run order is split and forms the initial and final partial run. If the numerator sequence is to be calculated for this order, the initial numerator value will have to be calculated. For example, at 1101, the numerator value of the intercept is b=23. We know that all of the numerator values of order 1 are less than p^{[1]}=a=17. Therefore the initial value of the order 0 numerator sequence will not be the same as the initial value of the order 1 numerator sequence and the initial and final runs of order 1 will be truncated.

Using Hierarchies of Runs to Generate Lines

There are many line drawing techniques that take advantage of the structure of a line's intersection pattern. At the pixel level, the standard line drawing algorithm of Bresenham may be employed. In this algorithm, the point at which the line intersects the current pixel determines whether the next pixel's y coordinate is incremented by 1. See J. E. Bresenham, “An incremental algorithm for digital plotting”, ACM National Conference, August 1963. Bresenham's algorithm may be used only with lines whose start and end coordinates are rational numbers. Where the starting and end coordinates may be any real number, the well-known DDA algorithm must be used. See A. Van Dam, J. Foley, S. Feiner and J. Hughes, Computer Graphics: Principles and Practice, Second Edition in C, Addison-Wesley (1995). Like Bresenham's algorithm, DDA works at the pixel level. Initially, floating-point x and y increments are computed. The x increment is the difference between the ending and starting x coordinates divided by the line's length and they increment is the difference between the ending and starting y coordinates divided by the line's length. Each time a pixel is set, the current x and y coordinates, which are floating point values, are converted to integers and the pixel is set at the cell defined by the increment. Then the x increment is added to the x coordinate and the y increment is added to the y coordinate. A difficulty with any pixel-by-pixel approach is that it requires a determination where the next pixel will be placed relative to the last pixel for each new pixel. With the DDA algorithm, this determination is a floating-point operation. As such, it is both expensive to perform and subject to rounding errors. Moreover, because the determination must be performed with every pixel, the rounding errors may accumulate quickly and cause the line to be drawn inaccurately.

The overhead of computing the location of the next pixel relative to the last is avoided in algorithms that use runs of pixels instead of individual pixels to draw the line. At the level of a run of order 1, Reggiori has developed an algorithm that determines the length of the next run in the line from the set of two possibilities. See G. B. Reggiori, “Digital computer transformations for irregular line drawings”, Technical Report 403-22, New York University, April 1972. Stephenson generalizes these techniques to the full hierarchy of runs in the line including runs of runs, runs of runs of runs, etc. See P. Stephenson, The structure of the digitized line, Ph.D thesis, James Cook University of North Queensland, 1998, which is incorporated by reference herein. Like Bresenham's algorithm, the algorithms that use runs and run hierarchies are limited to lines whose start and end points have rational number coordinates.

All of these algorithms possess a similar conditional structure regardless of whether they are based on pixels such as Bresenham's pixel-based algorithm or the DDA algorithm, runs such as Reggiori's algorithm, or a mixture of runs and runs of runs such as the run length slice algorithms. The slopes that are considered are bounded to lie in the range 0<α<1. For pixel-based algorithms that limits the choice of the next pixel to a possible set of two. For run-based algorithms, the choice is made between the two possible run lengths that can exist in the line. In all of these algorithms the choice is made by checking the value of a decision parameter against the value of zero. For values less than zero, one element of the possible set of choices is used; for values greater than zero, the other choice. For a value of zero, each technique handles this case differently. For line drawing applications, either choice is equally applicable and for ray tracing, this typically signifies a corner intersection.

While the prior-art line drawing techniques that use runs and hierarchies of runs are useful and efficient, they are limited to lines whose starting and end points have rational number coordinates. In order for these line drawing techniques to be completely general, what is needed is versions of the techniques that work with lines that have end points whose coordinates may be any real number. It is thus an object of the present invention to provide such line drawing techniques.

### SUMMARY OF THE INVENTION

The object of the invention is attained by a method of making a determination in a lattice of a set of cells of the lattice that are intersected by a line. The line may have any algebraic real number as a coordinate, including an irrational number. The lattice is represented in memory that is accessible to a processor and the determination is done according to a technique that employs orders 1 . . . n of runs of lattice cells to make the determination. The method comprises the steps of

initializing the determination by

deriving an error term with real number value and a structural parameter with a real number value for order 1 using the values of the coordinates for the endpoints and

performing the step beginning with order 2 for each new order i, 2≦i≦n of determining an error term with a real number value for the order i using the error term and structural parameter from order i−1; and thereupon

making the determination for runs of order n using the error term and structural parameter for order n.

The method may further include the step performed if any of the first runs of the orders 1 through n is truncated of using the error parameter to determine the cells belonging to the truncated run of the order. Another step which may be included is using the structural parameter for order n to update the error term for order n after the determination has been made for each run of order n. In other aspects of the method, for a non-truncated run of order n, only the error term for the run of order n need be computed and the method terminates when the cell that contains the ending coordinates for the line is determined to belong to the set of cells.

In addition, each order of the runs has a type and a shape, with the order 1 having a predefined type and the method further comprises the steps performed for each order 2 through n of

using the structural parameter for order i−1 to determine the type of order i; and

using the type of order i and the type of order i−1 to determine the shape of order i.

In another step, the type of order i may further be used to determine the structural parameter for order i. In a still further step, the structural parameter and the type for each order i are stored in storage accessible to the processor.

The invention further includes a method of beginning a determination in a lattice of a set of cells of the lattice that are intersected by a line. The lattice is represented in memory accessible to a processor and the determination is done by the processor according to a technique that determines runs of cells that are intercepted by the line. The method comprises the steps performed by the processor of

determining whether the starting point of the line is within a cell of the lattice; and

when the starting point is within the cell, including the cell in the set as the first cell of the set and making determination of further cells belonging to the set according to the determination technique.

The method may further comprise the step performed when there is an included cell of using the position of the line's starting point relative to the left-hand side of the cell and the bottom of the cell and the slope of the line to determine whether a next cell to be included in the set has the same y coordinate as the included cell or the next higher y coordinate for a cell.

In any of the methods, the cells of the lattice may represent pixels and the method is used to construct a pixel representation of the line in the lattice.

Other objects and advantages will be apparent to those skilled in the arts to which the invention pertains upon perusal of the following Detailed Description and drawing, wherein:

### BRIEF DESCRIPTION OF THE DRAWING

FIG. 1 is an overview of the manner in which lines are drawn using the techniques of the invention;

FIG. 2 is an overview of a system which draws lines using the techniques of the invention;

FIG. 3 is a flowchart of how the bitmap processor processes complete runs of pixels;

FIG. 4 is a flowchart of how the bitmap processor processes truncated runs of pixels;

FIG. 5 is a flowchart of how the bitmap processor processes a run of order 1;

FIG. 6 is a flowchart of how the first truncated run of an order i is processed and set;

FIG. 7 shows how the first pixel of a line is handled using the techniques of the invention;

FIG. 8 shows a flowchart of how a complete run of order i is processed;

FIG. 9 shows a system in which the invention may be employed;

FIG. 10 shows the structure of a representation of a line as a set of pixels;

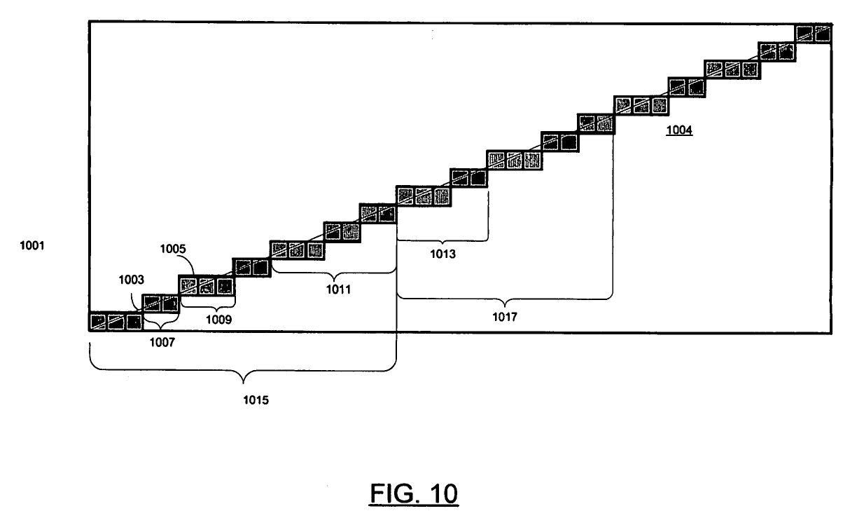

FIG. 11 shows the effect of a displacement of the starting point from the origin on the structure of the representation;

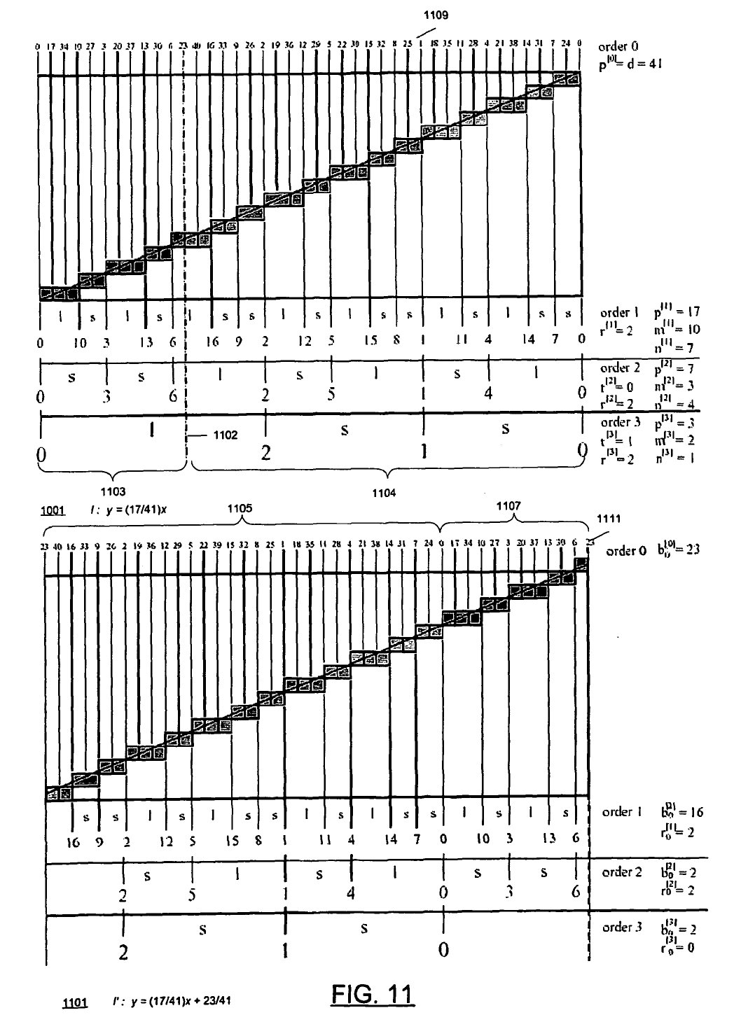

FIG. 12 shows an example line;

FIG. 13 shows how the first pixel of the example line is handled;

FIG. 14 shows truncated runs of orders 1-3 in the example line; and

FIG. 15 shows the geometry of the error term and structural parameters in a run of order 1.

### DETAILED DESCRIPTION

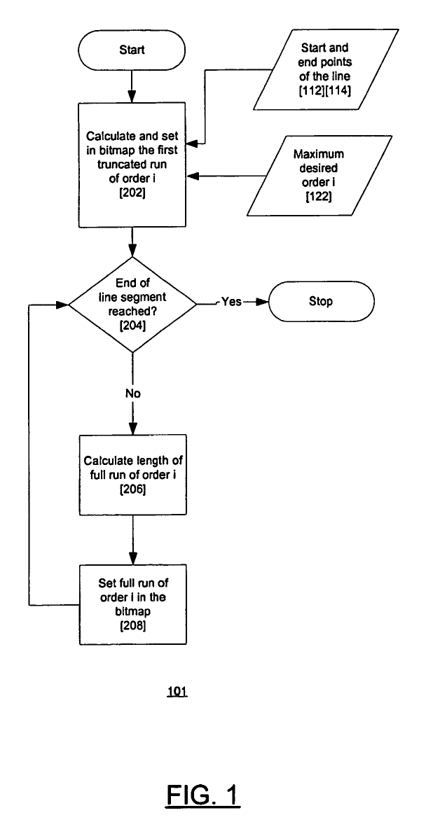

Overview of Line Drawing with the Invention: FIG. 1

FIG. 1 is a flowchart [101] that provides an overview of how a line segment may be drawn using this invention. Starting parameters include the maximum order of the runs to be used in drawing the lines [122] and the start and endpoints of the line [112,114]. The maximum order can be predefined by the manufacturer of an apparatus based on the invention, calculated based on the characteristics of the system or based on the length of the line. In the preferred embodiment the maximum order of the runs [120] is set to two.

The line segment defined between the starting point [112] (x₀,y₀) and the end point [114] (x₁,y₁) consists of, at most, three sets of runs of any order, i: The first truncated run of order i, the set of full-length runs of order i, and the final truncated run of order i. To draw the line segment from (x₀,y₀) to (x₁,y₁), we will describe how to calculate and set in the Bitmap Memory [108]:

The first truncated run of order i [202].

The full length runs of order i [206].

The final truncated run of order i while setting the full length runs of order i [206].

An alternative embodiment would calculate the first truncated run, each full length run and the final truncated run separately. Another alternative embodiment would have a desired maximum order [120] of infinity, and therefore the processing of the first truncated run length would draw the entire line segment unless the maximum depth of the hierarchy of runs was reached.

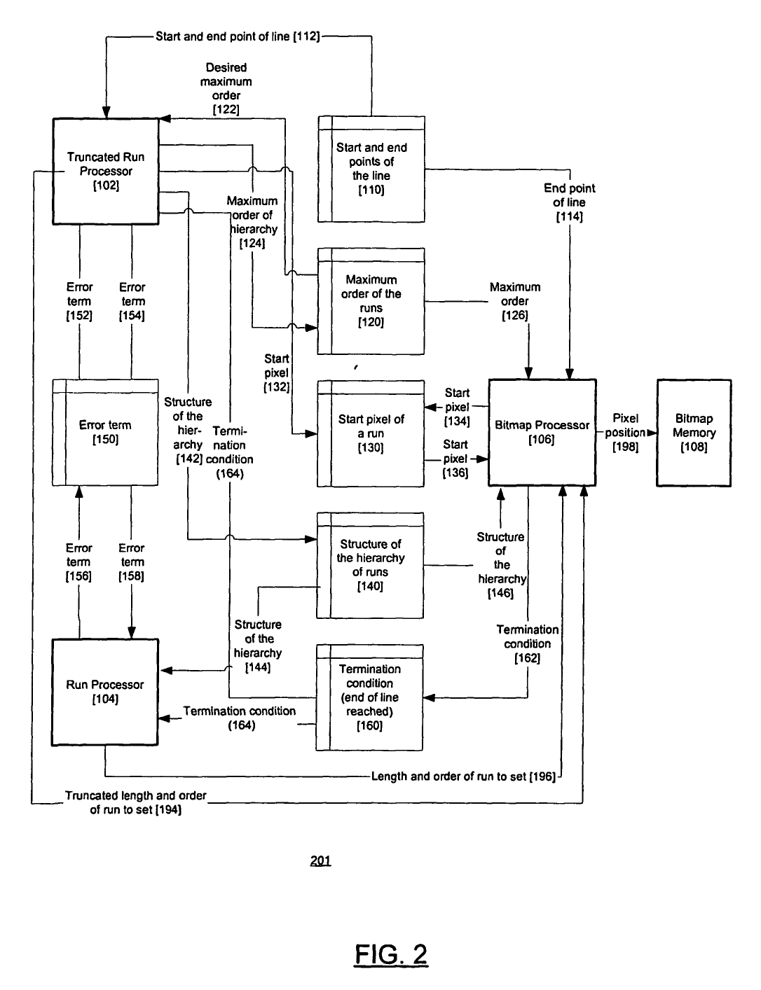

Overview of the Components of a System for Drawing Lines According to the Invention: FIG. 2

FIG. 2 shows the components of a system 201 for drawing lines according to the invention. The main components of system 201 are a Truncated Run Processor [102], which calculates the structure of the first truncated run of order i [202] and the structure of the hierarchy of runs [140] in the line segment, and the Run Processor [104], which calculates the length of the full length runs and the final truncated run [206]. To set the runs [202][208] into the Bitmap Memory [108], the description of each run is given to the Bitmap Processor [106]. The Bitmnap Processor is responsible for breaking the run into its composite pixels and setting each pixel into the Bitmap Memory [108].

Truncated Run Processor [102]

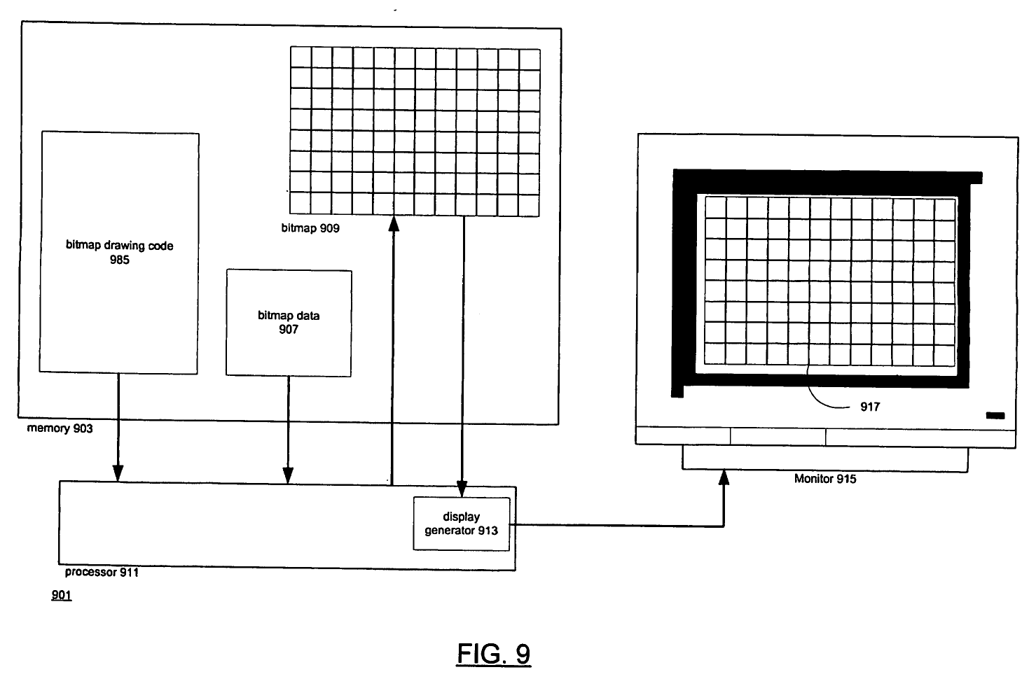

The Truncated Run Processor [102] is responsible for calculating the structure of the first truncated run of the desired order [120] and supplying this structure to the Bitmap Processor [106] so that the truncated run [194] can be set into the Bitmap Memory [108]. Bitmap memory [108] may be a bit map such as bitmap 909 in FIG. 9.

While the Truncated Run Processor calculates the structure of the first truncated run, it also calculates the structure of the hierarchy of runs [140] and stores this information [142] for the use by the Run and Memory Processors [104,106]. During this process if the desired maximum order of the process [120] is found to be greater than the maximum order of the hierarchy of runs in the line, the maximum order [120] is set to be the maximum depth of the hierarchy [124].

Based on the start and end points of the line [110], the Truncated Run Processor also calculates and stores [132] the starting pixel position for the line [130].

Each component of the first truncated run is calculated based on the error term [150]. As each component is processed the error term is retrieved [152], updated and stored again [154]. Once the first truncated run has been processed, the error term remaining [150] is used by the Run Processor [104] to define the full-length runs in a similar manner.

Run Processor [104]

The Run Processor [104] is responsible for calculating the length of each full-length run of the desired maximum order in the digital line. These lengths are passed to the Bitmap Processor [106] such that the runs can be set into the Bitmap Memory [108]. The length of the full-lengths is decided based on the error term [150], which is retrieved [156], updated and stored [158] to process the next full-length run. Thus, the error term is recalculated only at the beginning of each full-length run of the maximum order instead of for each pixel.

Bitmap Processor [106]

The Bitmap Processor [106] is responsible for actually setting the runs into the Bitmap Memory [108].

We assume there is a method to set a pixel of the memory to a desired value, similar to the setPixel(x, y, value) method described in the prior art. If a method to set a run of higher order, the Bitmap Processor [106] can take advantage of this function.

The Bitmap Processor [106] also keeps a track of the current position of the line being drawn in relation to the end point of the line [110]. If the line moves reaches the end point [114], the Bitmap Processor [106] signals the Truncated Run Processor [102] or the Run Processor [104] to terminate [162] using an internally stored termination condition [160].

Bitmap Memory [108]

The Bitmap Memory [108] is the memory representing the raster display of a graphics system, video memory, image memory or any other type of bitmap.

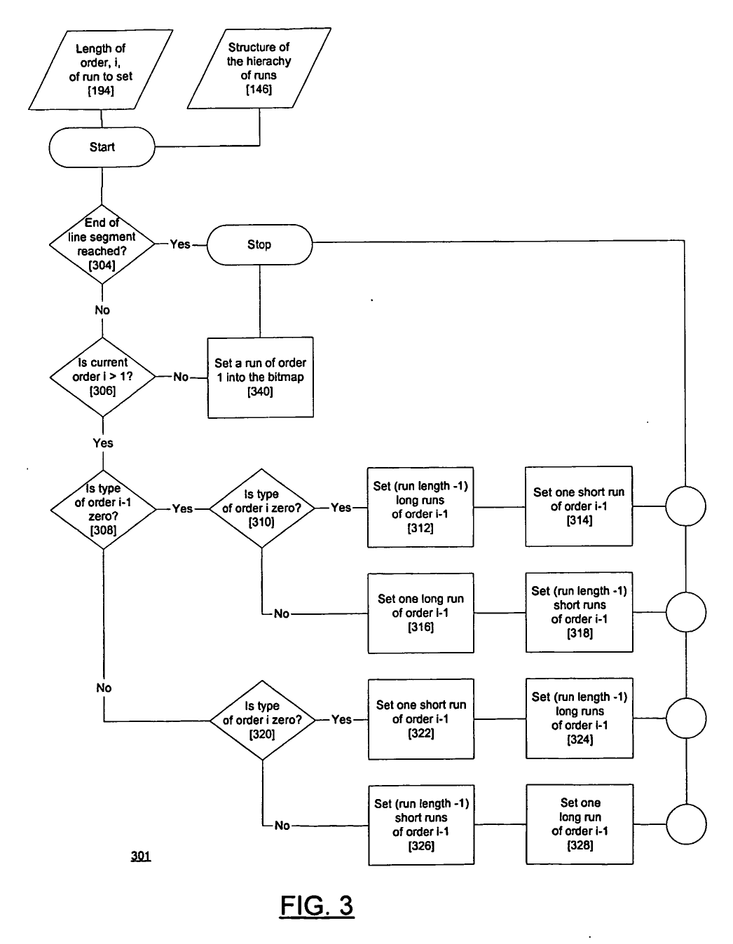

Details of Operation of the Components of System 201: FIGS. 3-8

For the remainder of this description we will describe:

1. How a truncated or full-length run of order i [202][208] is set into the Bitmap Memory [108] via the Bitmap Processor [106].

2. How the first truncated run of order i in the line segment is processed [202] by the Truncated Run Processor [102].

3. How the full-length runs of order i in the line segment [208] are processed by the Run Processor [104].

How a Run of Order i is Set into the Bitmap Memory Via the Bitmap Processor: FIG. 3

The Bitmap Processor [106] handles the process of setting the pixels of the Bitmap Memory [108]. To draw the line, the Bitmap Processor is given a set of commands [194][196] to draw a collection of runs of various orders into the Bitmap Memory. The information given in the command to draw a run is the length of the run, rⱼ^{[i]}, and the order of the run, i [194][196]. The position of the run in the bitmap [130], (xⱼ^{[i]},yⱼ^{[i]}), is initialized [132] by the Truncated Run Processor [102] and is retrieved by the Bitmap Processor [136]. As the run is drawn, the coordinate is updated to the position of the next run of order i, and is stored for the next iteration [134].

The process of setting a run in the Bitmap Memory, involves reducing the run to a set of pixels and setting each individual pixel in the Bitmap Memory. Reducing the run of order i into runs of order 0 (pixels) is performed by recursively reducing the run of order k to runs of order k−1 for each order from k=i to k=2 resulting in a description of the run of order i in terms of runs of order 1. Each pixel in the run of order 1 is then set into memory.

We therefore describe:

How a full-length run of order i is reduced into runs of order i−1.

How the first truncated run of order i is reduced into runs of order i−1.

How the pixels of a run of order 1 are set into the Bitmap Memory.

In an alternative embodiment, if the Bitmap Memory [108] permits the setting of runs of pixels or runs of runs, etc., the process of reducing the run of order i to runs of order i−1 can be stopped at the permitted level. Therefore instead of setting pixels into the Bitmap Memory, runs or runs of runs can also be used.

Reducing a Full-Length Run of Order k into Runs of Order k−1: FIG. 3

As described in the Description of related art, each run of any nonzero order i within the digital line has, at most, only two possible run lengths that are consecutive integers where the length is measured as the number of composite runs of the next lowest order, i−1. As a consequence of this, we can denote the occurrence of a short run by the symbol s and a long run by the symbol l. For example the runs of order 1 in the line segment (0, 0) to (41, 17) can be described by (lslslsslslsslslss)^{[1]}.

A run of order i can then be defined recursively by:

A run of order 1 is the maximal set of contiguous pixels with a similar abscissa.

A run of order i is the maximal set of contiguous runs of order i−1 such that each run has a shape (l⁺s)^{[i-1]}, (ls⁺)^{[i-1]}, (s⁺l)^{[i-1]}, or (sl⁺)^{[i-1]}, where (l⁺)^{[i-1]} and (s⁺)^{[i-1]} denote the occurrence of one or more long and short runs of order i−1 respectively.

We note that a run of order 2 can only possess the shape (l⁺s)^{[1]} or (ls⁺)^{[1]}.

Each run of any given order in the line segment has the same shape. To determine for a given order which of the four shapes is to be used, we define the runs of each order to have a type, t^{[i]}, which has a value 0 or 1. For a run of order i:

If t^{[i-1]}=0 and t^{[i]}=0 the shape of the run of order i is s^{[i]}=0:l⁺s.

If t^{[i-1]}=0 and t^{[i]}=1 the shape of the run of order i is s^{[i]}=1:ls⁺.

If t^{[i-1]}=1 and t^{[i]}=0 the shape of the run of order i is s^{[i]}=2:sl⁺.

If t^{[i-1]}=1 and t^{[i]}=1 the shape of the run of order i is s^{[i]}=3:s⁺l.

The type of order 1, t^{[i]}, is defined to be zero. The types of orders greater than 1 are calculated using structural parameters; the structural parameters and their calculation will be described in detail below.

To reduce a run of order i to the composite runs of order i−1, the procedure 301 shown in FIG. 3 is followed.

Inputs to the process are the length of the run of order i to be set [194] and the structure of the hierarchy of runs. The process will cease if the end point of the line has been reached [304].

If the order of the run is 1 [306], the pixels of the run are set directly [340] into the Bitmap Memory.

If the order of the run is at least 2, the run is reduced into its composite runs of the next lesser order and each run is set into the Bitmnap Memory:

If t^{[i-1]}=0 and t^{[i]}=0 the shape of the run is s^{[i]}=0:l⁺s, therefore we set in order rⱼ^{[i]}−1 long runs of order i−1 (length rₗ^{[i-1]}=rₛ^{[i-1]}+1) and one short run of order i−1 (length rₛ^{[i-1]}).

This process follows the path from [308], [310], [312], [314].

If t^{[i-1]}=0 and t^{[i]}=1 the shape of the run is s^{[i]}=1:ls⁺, we set one long run of order i−1 (length rₗⁱ⁻¹=rₛ^{[i-1]}+1) and rⱼ^{[i]}−1 short runs of order i−1 (length rₛ^{[i-1]}).

This process follows the path from [308], [310], [316], [318].

If t^{[i-1]}=1 and t^{[i]}=0 the shape of the run is s^{[i]}=2:sl⁺, we set one short run of order i−1 (length rₛ^{[i-1]}) and rⱼ^{[i]}−1 long runs of order i−1 (length rₗ^{[i-1]}=rₛ^{[i-1]}+1).

This process follows the path from [308], [320], [322], [324].

If t^{[i-1]}=1 and t^{[i]}=1 the shape of the run is s^{[i]}=3:s⁺l, we set rⱼ^{[i]}−1 short runs of order i−1 (length rₛ^{[i-1]}) and one long run of order i−1 (length rₗ^{[i-1]}=rₛ^{[i-1]}+1).

This process follows the path from [308], [320], [326], [328].

The type and length of the short and long runs of any order are stored in the structure of the hierarchy of runs [146].

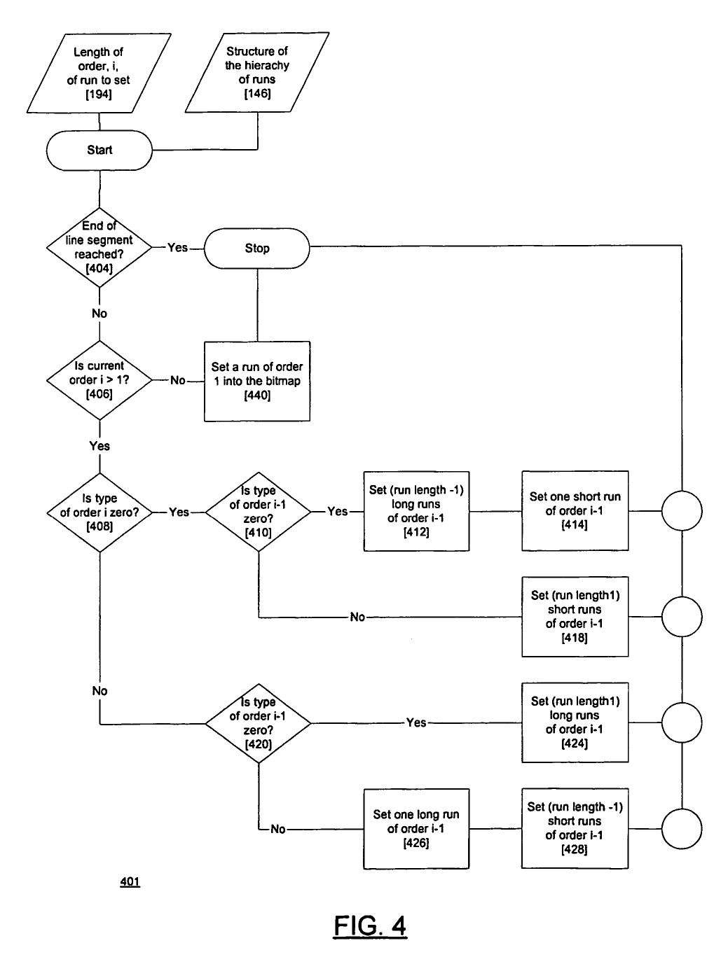

Reducing the First Truncated Run of Order k into Runs of Order k−1: FIG. 4

The process of reducing the first truncated run of order k into full-length runs of order k−1 follows directly from the instructions to reduce full-length runs. The only variation comes from the fact that a truncated run is defined to be a run not of its full-length. Therefore at least one run of order k−1 has been truncated from the run of order k. Because this is the first run in the line, the truncated run occurs at the beginning of the run. In a preferred embodiment, the truncated runs received by the Bitmap Processor have a length of at least one. Therefore the only situations that need to be handled differently are when shapes s^{[i]}=1:ls⁺ and s^{[i]}=2:sl⁺ occur.

The process is shown at 401 in FIG. 4. As with the process for a full-length run, the inputs are the length of the run of order i that is to be set [194] and the structure of the hierarchy of runs [146] . The process 401 will cease if the end point of the line has been reached [404].

If the order of the run is 1 [406], the pixels of the run are set directly [440] into the Bitmap Memory

If the order of the run is at least 2, the run is reduced into its composite runs of the next lesser order and each run is set into the Bitmap Memory:

If t^{[i-1]}=0 [408] and t^{[i]}=0 [410], the shape of the run is s^{[i]}=0:l⁺s. As the run is truncated, at least one run of order i−1 is removed from the beginning of the run. As the length of the truncated run is r₀^{[i]}, this leaves r₀^{[i]}−1 long runs of order i−1 and the final short run of order i−1. For example if the first run at full length is the sequence of runs (lllls)^{[i-1]} and the initial truncated run length is r₀^{[i]}=3, the truncated run comprises two long runs and the final short run of order i−1:(lls)^{[i-1]}. Therefore to set the initial truncated run length, we set in order r₀^{[i]}−1 long runs of order i−1 (length rₗ^{[i-1]}=rₛ^{[i-1]}+1) [412] and one short run of order i−1 (length rₛ^{[i-1]}) [414].

Similarly, if t^{[i-1]}=0 [408] and t^{[i]}=1 [410], the shape of the run is s^{[i]}=1:ls⁺. The truncated run has less runs than a short run of order i, therefore given the shape of the run ls+, there can only be short runs of order i−1 comprises the truncated run. Therefore we set r₀^{[i]} short runs of order i−1 (length rₛ^{[i-1]}) [418].

If t^{[i-1]}=1 [408] and t^{[i]}=0 [420] the shape of the run is s^{[i]}=2:sl⁺, we set r₀^{[i]} long runs of order i−1 (length rₗ^{[i-1]}=rₛ^{[i-1]}+1) [424].

If tⁱ⁻¹=1 [408] and t^{[i]}=1 [420] the shape of the run is s^{[i]}=3:s⁺l, we set r₀^{[i]}−1 short runs of order i−1 (length rₛ^{[i-1]}) [426] and one long run of order i−1 (length rₗ^{[i-1]}=rₛ^{[i-1]}+1) [428].

The type and length of the short and long runs of any order are stored in the structure of the hierarchy of runs [146].

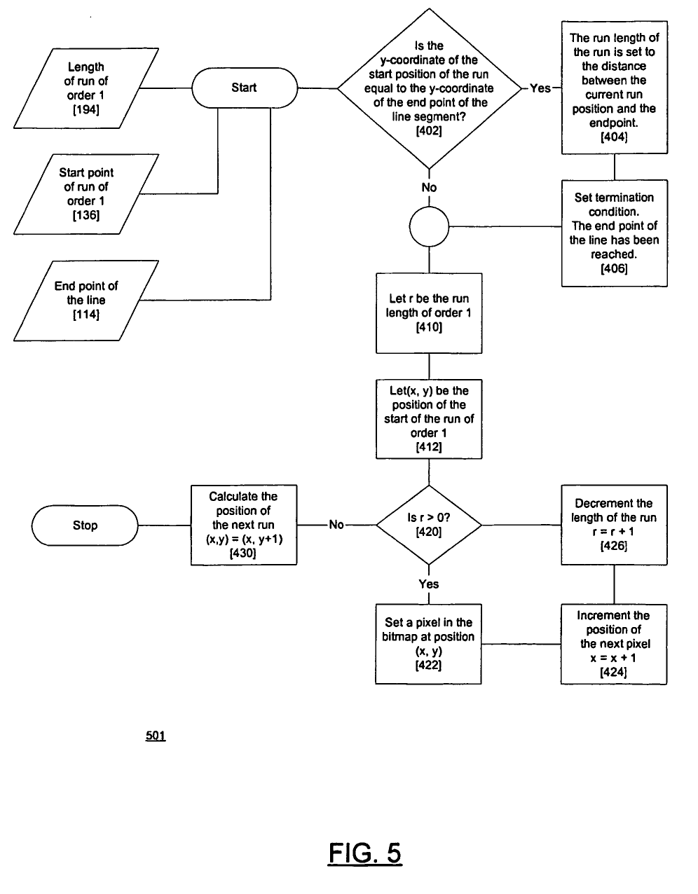

Setting the Pixels of a Run of Order 1 into the Bitmap Memory: FIG. 5

FIG. 5 is a flowchart 501 showing how to set the pixels of a run of order 1 [340]. The method requires as inputs the starting pixel [136], (xⱼ^{[1]},yⱼ^{[1]}), the end point of the line [114], and the length of the run [194], rⱼ^{[1]}, are required. The starting pixel is stored and updated internally [136]. The length of the run [194] is passed to the Bitmap Processor.

Each pixel in the run has a similar y-coordinate, which is the y-coordinate of the starting pixel [136], yⱼ^{[1]}.

If the y-coordinate for the run being set is the same as the floor of the y-coordinate of the end point of the line, yⱼ^{[1]}=└y₁┘, the run being set is the last run in the line [402]. In this case:

The termination condition [160] signaling that the end point of the line has been reached is set [406].

The length of the run to be set [194] is changed to the difference between the x-coordinate of the start of the run being set and the ceiling of the x-coordinate of the endpoint of the line, rⱼ^{[1]}=┌x₁┐−xⱼ^{[1]} [404].

The run of pixels of length rⱼ^{[1]}=┌x₁┐−xⱼ^{[1]} is set in the Bitmap Memory at location (xⱼ^{[1]},yⱼ^{[1]}).

To set each of the pixels in the run into the Bitmap Memory, for each of the pixels in the run [410][420][426] starting at the pixel (xₖ^{[0]},yₖ^{[0]})=(xⱼ^{[1]},yⱼ^{[1]}) [412]:

Set the pixel (xₖ^{[0]},yₖ^{[0]}) into the Bitmap Memory [422].

Move to the position of the next pixel, (xₖ₊₁^{[0]},yₖ₊₁^{[0]})=(xₖ^{[0]},yₖ^{[0]}) [424].

Once every pixel in the run has been set into the Bitmap Memory, the starting coordinate of the next run of order 1 in the line is calculated from the current coordinate value by incrementing the current y-coordinate of the next pixel position [430], (xⱼ₊₁^{[1]},yⱼ₊₁^{[1]})=(xₖ^{[0]},yₖ^{[0]}+1).

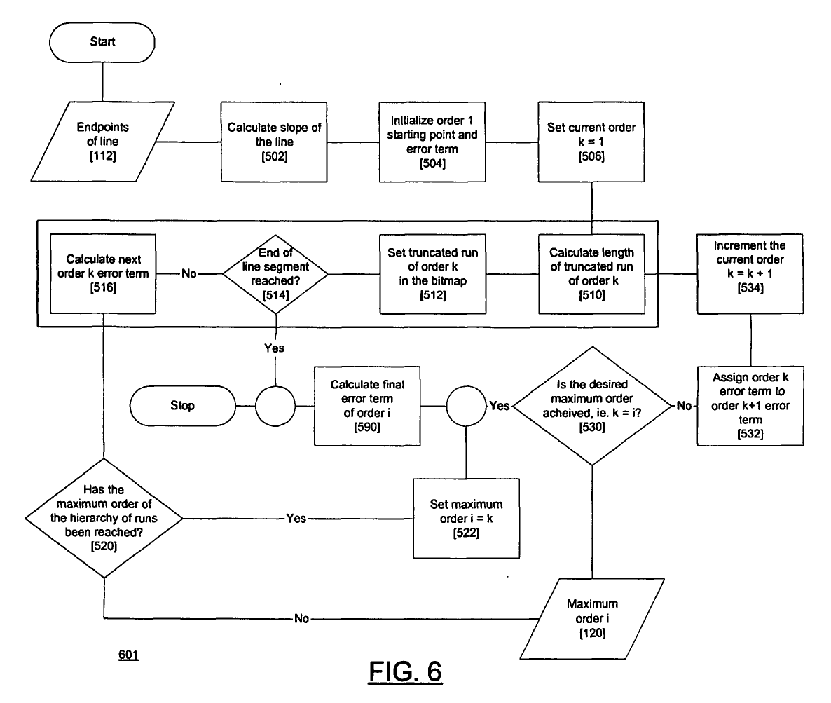

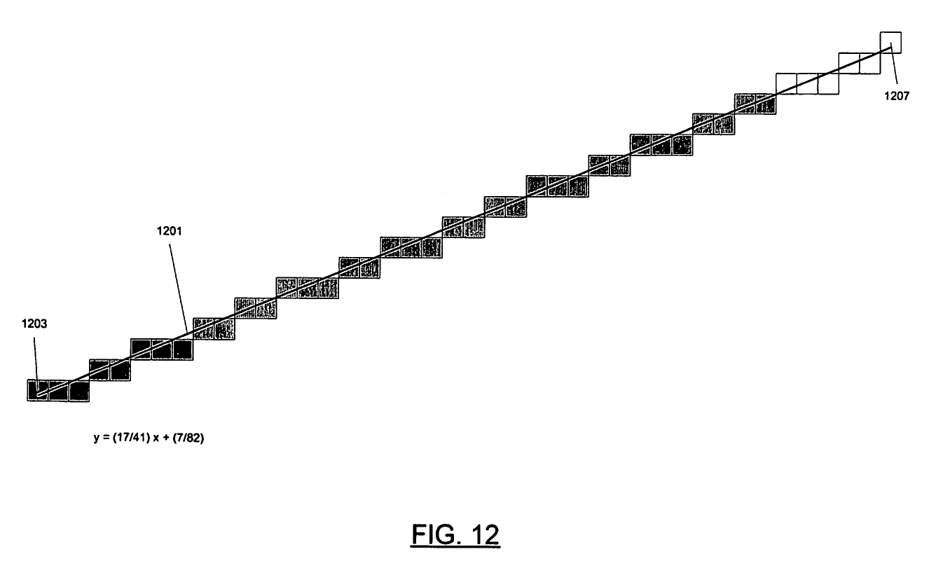

How the First Truncated Run of Order i in the Line Segment is Processed by the Truncated Run Processor: FIGS. 6 and 12

To calculate the length of the initial truncated run length of the maximum order i [120] we calculate and set in the Bitmap Memory each initial truncated run length of order 1 to i in turn. This is shown in flowchart 601 of FIG. 6. If no truncated run length exists for any order, none is set. The process stops if:

The endpoint of the line [110] is reached [514].

The maximum depth of the hierarchy is reached [520].

The desired maximum order is reached [530].

A truncated run length of order k is of course made up of run lengths of orders 0 through k−1. In the above technique, the orders 1 through k are processed beginning with order i=1 and moving order by order to i=k. With each of the orders, the bits for that order are set before the next higher order is processed. For a given order i, the bits set for order i−1 will always make up the complete truncated or untruncated first run of the order i.

Initialize the Slope of the Line [502].

The endpoints of the line segment are the real number coordinates (x₀, y₀) and (x₁, y₁) [112], such that x₀≦x₁ and y₀≦y₁, therefore the slope of the line, α, has a value between zero and one, 0≦α<1.

The slope of the line is calculated by α=(y₁−y₀)/(x₁−x₀) [502]. In example line 1201 of FIG. 12, the equation of the line is y=17x/41+7/82, therefore α=17/41. Example line 1201's endpoint (x₀, y₀) 1203 is (½,12/41); its endpoint (x₁,y₁) 1207 is (41+½,17+12/41). Note that while the coordinates of the endpoints are rational numbers in this case, a coordinate may be any real number.

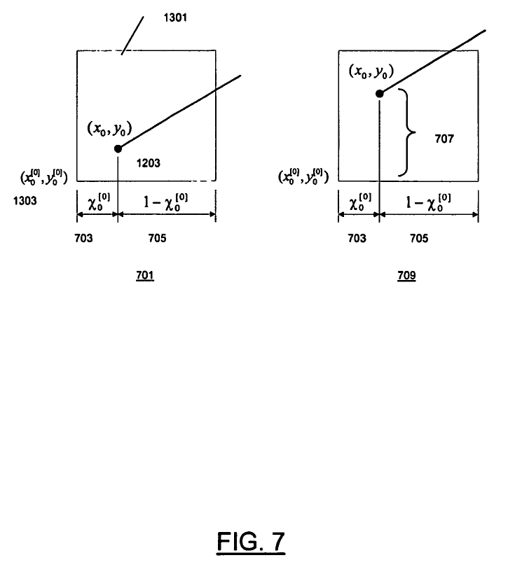

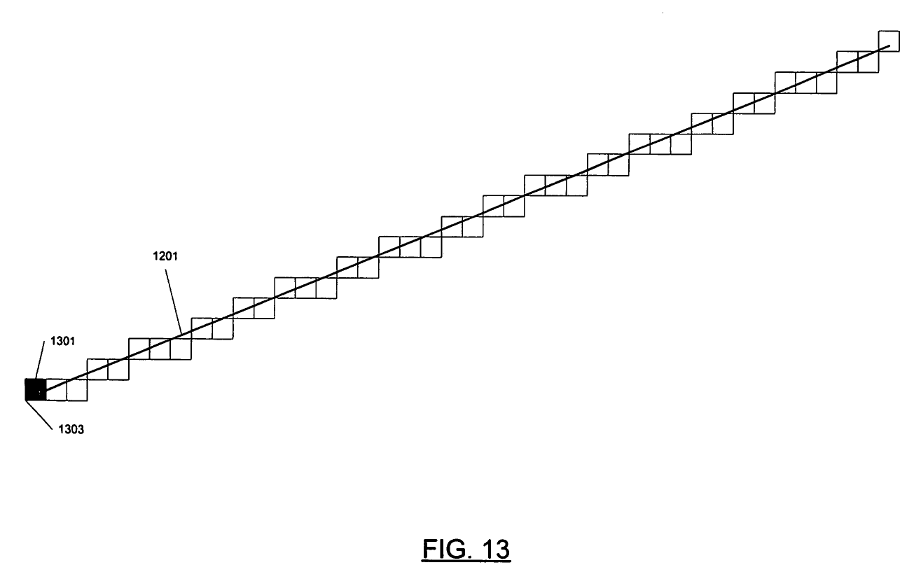

Initialize Order 1 Starting Pixel and Error Term [504]: FIGS. 7 and 13

The first step in the algorithm is to handle the pixel in which the start point of line lies as described in FIG. 13. At the completion of this step, the dark pixel 1301 at the start of the line will have been processed.

As may be seen from FIG. 13, the coordinates of the lower left-hand comer 1303 of pixel 1301 that contains the start point 1203 of line 1201 is:

x₀^{[0]}=└½┘=0

y₀^{[0]}=└12/41┘=0

To decide whether to set the first pixel in the line separately from the first run we define the distance χ₀^{[0]} 703 from the start point of the line to the beginning of the pixel as described in FIG. 7:

χ₀^{[0]}=x₀−x₀^{[0]}

or ½ in our example. If χ₀^{[0]}≠0, the first pixel must be set separately from the first run.

We also require the initial value error term \hat{β}₀^{[0]} of order zero normalized against the slope of the line. Given the average run length in the line τ^{[1]}=41/17 in example line 1201,

\hat{β}₀^{[0]}=(y₀−y₀^{[0]})τ^{[1]}=12/17

where y₀−y₀^{[0]} is the distance from the y coordinate of starting point 203 to the y coordinate of the lower left-hand corner 1303 of pixel 1301 and

$${τ}^{[ 1 ]} = \frac{1}{{α}^{1}} .$$

Since χ₀^{[0]} is nonzero, the Bitmap Processor sets a run of order 0 (a pixel) into the bitmap memory at the location (x₀^{[0]},y₀^{[0]})=(0,0). There are two choices for the position of the next pixel in the line segment (1,0) or (1,1). The choice from these two is made using the value of the error term \hat{β}₀^{[0]}. There are two choices for the position of the next pixel in the line segment (x₀^{[0]}+1,y₀^{[0]}) and (x₀^{[0]}+1,y₀^{[0]}+1). The choice from these two is made by the value of the error term \hat{β}₀^{[0]}. Firstly increment the x coordinate and calculate the next error term of order 0:

x₀^{[0]}=x₀^{[0]}+1

\hat{β}₀^{[0]}=\hat{β}₀^{[0]}+1−χ₀^{[0]}

In the example of FIG. 7, this comes out to 12/17+1−½=41/34, which is less than τ¹, which equals 41/17.

If the error term is less than the average run length of order 1 as shown at 701 in FIG. 7, the next pixel is pixel (x₀^{[0]}+1,y₀^{[0]}).

if \hat{β}₀^{[0]}<τ^{[1]} then

y₀^{[1]}=y₀^{[0]}

If the error term is greater than or equal to the average run length of order 1 as shown at 709 in FIG. 7, the next pixel is pixel (x₀^{[0]}+1,y₀^{[0]}+1). Accordingly the error term is also updated.

if \hat{β}₀^{[0]}≧τ^{[1]} then

y₀^{[0]}=y₀^{[0]}+1

\hat{β}₀^{[0]}=\hat{β}₀^{[0]}−τ^{[1]}

If χ₀^{[0]} is zero, the values of position of the pixel and the error term are not altered and no pixel is set into the memory.

The position of the next run of order 1 in the line segment and the first error term of order 1 is now the position of the next order 0 run and error term of order 0.

x₀^{[1]}=x₀^{[0]}

y₀^{[1]}=y₀^{[0]}

The coordinate (x₀^{[1]},y₀^{[0]}) is stored as the position of the next run in the line segment [130].

The error term \hat{β}₀^{[0]} is stored [152] as the error term for the next run [150].

Setting the First Truncated Run of Order i>0

Once the first order has been initialized [504][506], the first truncated run of order 1 through i is set, where i is either the desired maximum order [122] or the maximum order in the hierarchy of runs in the line [124].

The process for setting the first truncated run of order k=1 is as follows. Starting at order k=1 [506]:

1. Calculate the length of the first truncated run of order k [510], r₀^{[k]}.

2. Set the truncated run of order k into the Bitmap Memory [512] if the run is truncated.

3. Check that the end point of the line has not been reached [514]. If it has, cease processing and if it has not continue.

4. Calculate the next error term of order k [516].

5. Check if k is the maximum depth of the hierarchy of runs in the line [520]. If so, set the maximum order of runs [120] to be the maximum order of the hierarchy of runs [124], update and store [152] the final value of the error term [150] [590] and cease processing. If not continue.

6. Check if k is the desired maximum order of runs for the line [530]. If so, update and store [152] the final value of the error term [150] [590] and cease processing. If not continue.

7. The current error term of order k is the next error term for order k+1 [532].

8. Move to the next order [534], k=k+1.

Structure of the Hierarchy of Runs

During this process the structure of the hierarchy of runs will be calculated and stored [140]. The structure of the hierarchy of runs stores a description of each level in the hierarchy from order 1 to the defined maximum order [120]. Each record of the description for order i stores the following entries:

The slope of the line of order i, α^{[k]}.

The slope of the line of order 1 is defined to be the slope of the line, α^{[1]}=α.

The slope of the line of order k>1, α^{[k]}=min(\hat{μ}^{[k-1]},\hat{ν}^{[k-1 ]}).

The average length of a run of order i in the line, τ^{[k]}=1/α^{[k]}.

The length of a short run of order i, rₛ^{[k]}=└τ^{[k]}┘.

The length of a long run of order i, rₗ^{[k]}=|τ^{[k]}|.

The type of the runs of order i in the line, t^{[k]}, either 0 or 1.

The type of order 1 is defined to be t^{[1]}=0.

The type of order k>1 is defined to be t^{[k]}=0 if \hat{μ}^{[k-1]}≦\hat{ν}^{[k-1]}.

The type of order k>1 is defined to be t^{[k]}=1 if \hat{μ}^{[k-1]}>\hat{ν}^{[k-1]}.

The structural parameters \hat{μ}^{[i]} and \hat{ν}^{[i]}.

If the type of order k, t^{[k]}=0, then the structural parameters of order k,

\hat{ν}^{[k]}=τ^{[k]}−rₛ^{[k]}, and

\hat{μ}^{[k]}=1−\hat{ν}^{[k]}

If the type of order k, t^{[k]}=1, then the structural parameters of order k,

\hat{μ}^{[k]}=τ^{[k]}−rₛ^{[k]}, and

\hat{ν}^{[k]}=1−\hat{μ}^{[k]}

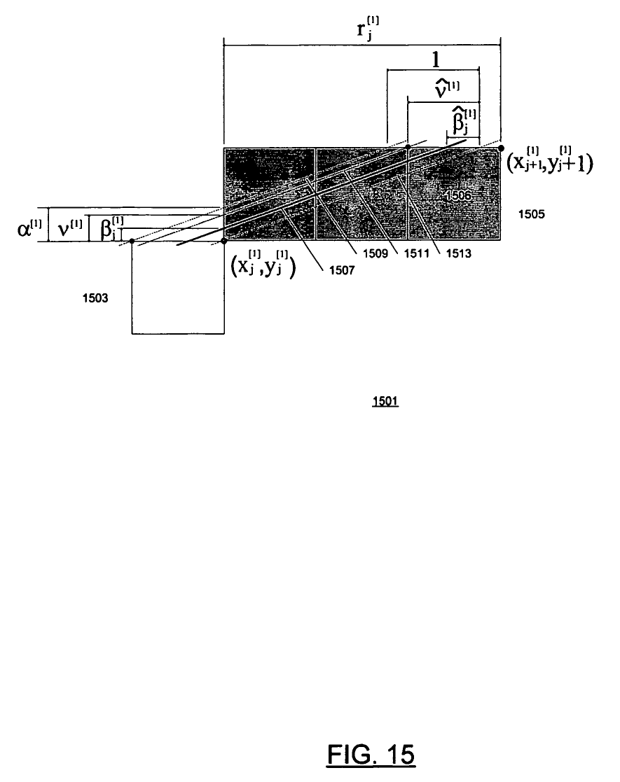

Geometry of the Error Parameter \hat{β}ⱼ^{[1]} and the Structural Parameters \hat{υ}^{[1]} and \hat{μ}^{[1]}: FIG. 15

As may be seen from the foregoing, the error parameter \hat{β}ⱼ^{[i]} is used to calculate lengths of runs and the structural parameters \hat{υ}^{[i]} and \hat{μ}^{[i]} are used to determine the type of an order. FIG. 15 shows geometrically why the error parameter and the structural parameters can be used in this fashion. The figure shows a first-order run j of pixels 1505 representing a portion of line 1507 with slope α. In first-order runs, the slope α^{[1]} of the run is the same as the slope of the line 1507. Shown at 1503 is the last pixel of the run j−1. The coordinates (xⱼ^{[1]},yⱼ^{[1]}) are the coordinates of the lower left-hand comer of the first pixel of run j; the coordinates (xⱼ₊₁^{[1]},yⱼ₊₁^{[1]}) are the coordinates of the lower left-hand corner of the first pixel of the first pixel of run j+1. The values of the error parameter and the structural parameters are defined geometrically by means of lines that are parallel to line 1507 and intersect corners of the pixels of run j. Thus, line 1509 intersects the upper left-hand comer of pixel 1503; line 1511 intersects the upper left-hand corner of the last pixel 1506 in run j; line 1513 intersects the bottom left-hand comer of the first pixel in run j.

The error parameter \hat{β}ⱼ^{[1]} is the distance on the line formed by the top of pixel 1506 between the intersections of lines 1507 and 1513 with that line. The greater the distance between lines 1507 and 1513, the shorter the next run must be. Moreover, since a line is drawn beginning with a partial run of the maximum order k and the partial run is made by beginning with a partial run of order 1, followed by a partial run of order 2, and continuing through order k, the error term for the partial run of order i is that resulting from order i−1.

The structural parameter \hat{υ}^{[1]} is the distance on the line formed by the top of pixel 1506 between the intersection of line 1513 with the line formed by the top of pixel 1506 and the upper left-hand corner of pixel 1506. The type of order 1 is defined to be 1, so the structural parameter \hat{μ}^{[1]}=1−\hat{υ}^{[1]}. The structural parameters vary with the slope α^{[i]} of the line as represented by runs of order i, and thus can be used to determine the type of order i+1.

Calculation of the Length of the Truncated Run

To calculate the length of the first truncated run of order k [510], r₀^{[k]}, first check if the run is truncated. If the run is not truncated, the length of the first run is assumed to be zero, r₀^{[k]}=0, an no run is set into the Bitmap Memory [512]. The first run of order k in the line is truncated if the stored error term [150], \hat{β}₀^{[k-1]}>1.

If the run of order k is truncated, the length of the run is:

r₀^{[k]}=|τ^{[k]}−\hat{β}₀^{[k-1]}| if type t^{[k]}=0.

r₀^{[k]}=|\hat{β}₀^{[k-1]}| if the type t^{[k]}=1.

If the run is not truncated, the error term for the next order is the same as this order \hat{β}₀^{[k]}=\hat{β}₀^{[k-1]}.

The run of order k and length r₀^{[k]} can now be set into the Bitmap memory.

If the run is truncated the initial truncated run length and initial decision value of order k is:

\hat{β}₀^{[k]}=r₀^{[k]}−τ^{[k]}+\hat{β}₀^{[k-1]} if the type t^{[k]}=0.

\hat{β}₀^{[k]}=\hat{β}₀^{[k-1]}−r₀^{[k]} if the type t^{[k]}=1.

At the end of the process of setting the initial truncated runs, we have drawn the first truncated run of order i in the line segment. We have the position of the next run of order i in the line if it exists, (x₁^{[i]},y₁^{[i]}) and the decision value \hat{β}₁^{[i]}. We therefore move to the next phase of the process which calculates the length of the next run of order i in the line, which is then set into the memory. The length of the next run of order i is decided from the two possible by the value of the decision variable, \hat{β}₁^{[i]}.

To update [590] the value of the error term of order i, \hat{β}₁^{[i]}, the value of \hat{β}₁^{[i]} is adjusted by −\hat{ν}^{[i]}, \hat{β}₁^{[i]}=\hat{β}₁^{[i]}−\hat{ν}^{[i]} and this value is stored [152] for use by the Run Processor [104].

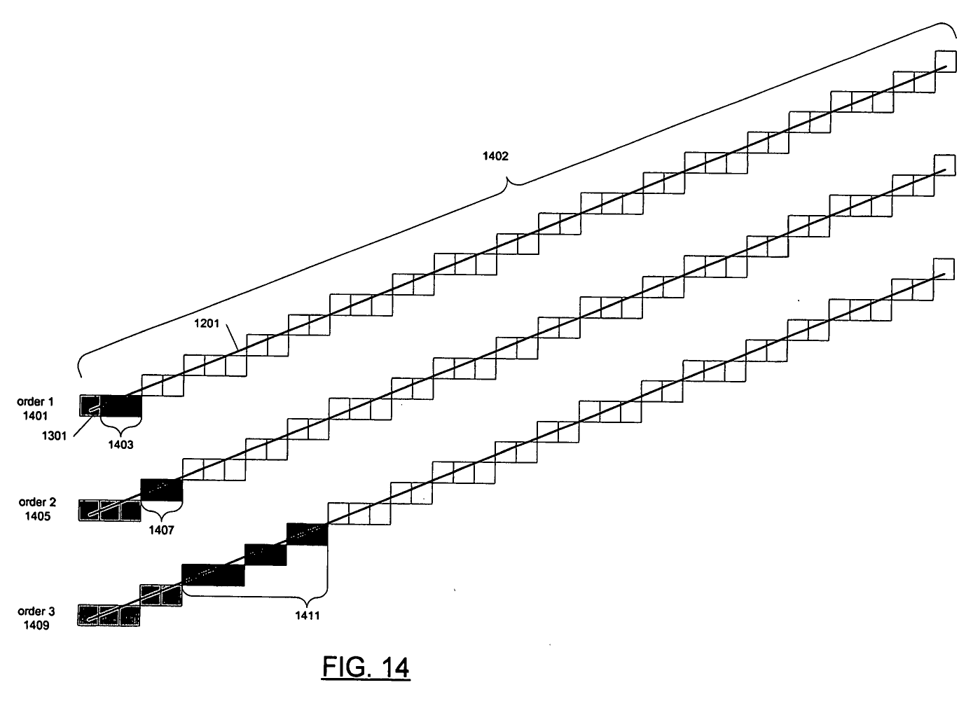

An Example of Setting Orders 1-3: FIG. 14

FIG. 13 shows line 1201 and the pixels 1402 that will be generated to represent it according to the technique under discussion. At 1401 is shown how the first truncated run 1403 of order 1 is set; at 1405 is shown how the first truncated run 1405 of order 2 is set; and at 1407 how the first truncated run of order 3 is set.

Once the first order has been initialized [504][506], the first truncated run of order 1 through i is set, where i is either the desired maximum order [122] or the maximum order in the hierarchy of runs in the line [124]. For the sake of the example, we will take the desired order to be i=3. As part of the initialization, first pixel 1301 has been set and the position of the next pixel relative to first pixel 1301 has been determined as described above.

Order 1

The next step is to handle the first truncated run of order 1 if it exists. In the example line, the portion on the line that will be processed is described by the dark pixels 1403.

The definition of the hierarchy of runs at order 1 in [146] is:

The slope of the line of order 1, α^{[1]}=17/41.

The average length of a run of order 1 in the line, τ^{[1]}=41/17.

The length of a short run of order 1, rₛ^{[1]}=└τ^{[1]}┘=2.

The length of a long run of order 1, r₁^{[1]}=|τ^{[1]}|=3.

The type of the runs of order 1 in the line is defined to be, t^{[1]}=0.

The structural parameters \hat{μ}^{[1]} and \hat{ν}^{[1]}.

\hat{ν}^{[1]}=τ^{[1]}−rₛ^{[1]}=7/17, and

\hat{μ}^{[1]}=1−\hat{ν}^{[1]}=10/17.

The length of the first truncated run of order 1 [510], r₀^{[1]}, is truncated since the stored error term [150], \hat{β}₀^{[0]}=41/34>1. The length of the truncated run is r₀^{[1]}=|τ^{[1]}−\hat{β}₀^{[0]}|=┌41/17−41/34┐=2 since the type t^{[1]}=0. The run of order 1 and length r₀^{[1]}=2 can now be set into the Bitmap memory at position (x₀^{[0]},y₀^{[0]})=(1,0). The initial decision value of order 1 is \hat{β}₀^{[1]}=r₀^{[1]}−τ^{[1]}+\hat{β}₀^{[0]}=2−41/17+41/34=27/34.

Order 2

The initial truncated run of order 2 1405 is described by the dark pixels 1407 in line 1201. The initial truncated run of order 2 has a length of one (i.e. one run of order 1). The position of the initial truncated run of order 2 is (x₀^{[2]},y₀^{[2]})=(x₀^{[1]}+r₀^{[1],y}₀^{[2]}+1)=(3,1).

The hierarchy of runs at order 2 is described by the parameters:

The slope of order 2, α^{[2]}=min(\hat{μ}^{[1]},\hat{ν}^{[1]})=7/17.

The average length of a run of order 2 in the line, τ^{[2]}=17/7.

The length of a short run of order 2, rₛ^{[2]}=2.

The length of a long run of order 2, rₗ^{[2]}32 3.

As \hat{μ}^{[1]}>\hat{ν}^{[1]}:

t^{[2]}=1

\hat{μ}^{[2]}=τ^{[2]}−rₛ^{[2]}=3/7

\hat{ν}^{[2]}=1−\hat{μ}^{[2]}=4/7

The first run of order 2 in the line is truncated because the stored error term [150] renormalized to the slope of order 2, \hat{β}₀^{[1]}=\hat{β}₀^{[1]}τ^{[2]}=27/14, is greater than 1. Therefore as t^{[2]}=1:

r₀^{[2]}=|\hat{β}₀^{[1]}|=1

\hat{β}₀^{[2]}=\hat{β}₀^{[1]}−r₀^{[2]}13/14

As the shape of the runs of order 2 is shape ls⁺, the last run of order 1 in a run of order 2 is a short run of order 1. A short run of order 1 has a length of two pixels. Therefore two pixels are set in this stage.

Order 3

The initial truncated run of order 3 1409 is described by the dark pixels 1411. The initial truncated run of order 3 has a length of one (i.e. one run of order 2). The runs of order 3 in the line have a shape s⁺l, the last run of order 2 in a run of order 3 is a long run. Therefore we will set a run of order 2 of length three.

The hierarchy of runs at order 3 is described by the parameters:

The slope of order 3, α^{[3]}=min(\hat{μ}^{[2]},\hat{ν}^{[2]})=3/7.

The average length of a run of order 3 in the line, τ^{[3]}=7/3.

The length of a short run of order 3, rₛ^{[3]}=2.

The length of a long run of order 3, rₗ^{[3]}=3.

As \hat{μ}^{[2]}<\hat{ν}^{[2]}:

t^{[3]}=0

\hat{ν}^{[3]}=τ^{[3]}−rₛ^{[3]}=⅓

\hat{μ}^{[3]}=1−\hat{ν}^{[3]}=⅔

The first run of order 2 in the line is truncated because the stored error term [150] renormalized to the slope of order 3, \hat{β}₀^{[2]}=\hat{β}₀^{[2]}τ^{[3]}=13/6, is greater than 1. Therefore as t^{[2]}=0:

r₀^{[3]}=|τ^{[3]}−\hat{β}₀^{[2]}|=┌⅙┐=1

\hat{β}₀^{[3]}=r₀^{[3]}−τ^{[3]}+\hat{β}₀^{[2]}=⅚

Therefore a single run of order 2 comprises the run of order 3. Now that the order chosen for the iterative portion of the technique has been reached, the normalized intercept value of order 3, \hat{β}₀^{[3]}32 ⅚, can be used to initialize the iterative decision process.

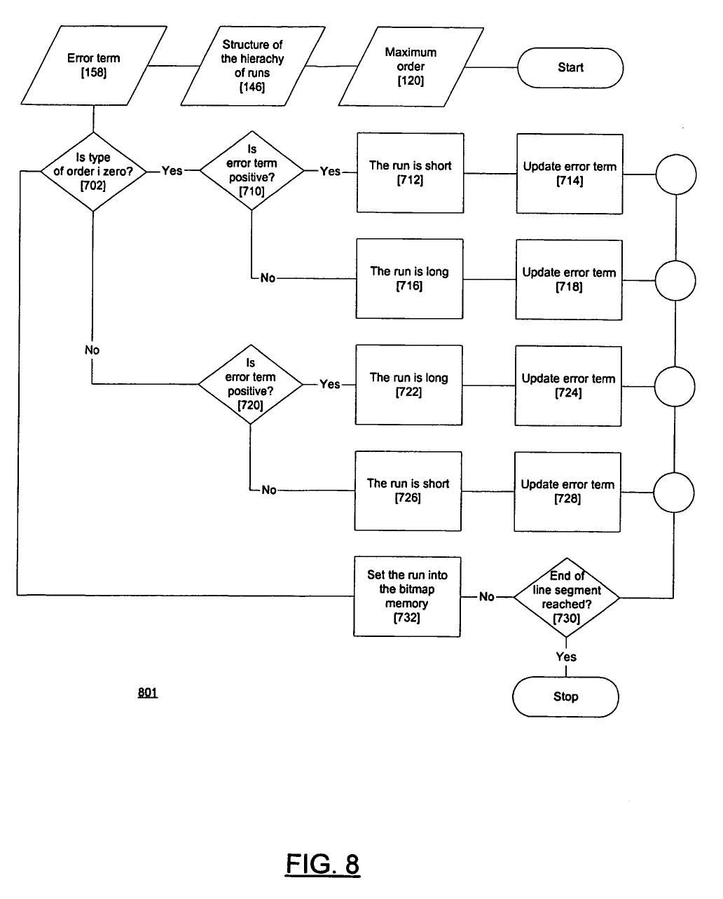

Setting Full-Length Runs of Order i in the Line: FIG. 8

To set a full length run of order i into the Bitmap Memory [108], the Run Processor [104] performs the steps shown in flowchart 801. The inputs are the maximum order of the runs (120), the structure of the hierarchy of runs [146] which was determined by truncated run processor [102] while processing the truncated runs, and the error term \hat{β}ⱼ^{[i]} provided by truncated run processor [102]. For each run of order i, the run processor determines the length of the run of order i in the line and passes the run's length and order to the Bitmap Processor [106] to set the actual pixels of the run into the Bitmap Memory [732]. The calculation of the length of the run of order i is based on the type of order (i) [702] and the value of the error term [150], \hat{β}ⱼ^{[i]}, retrieved [158] by the Run Processor [710,720]. Once the length of the run has been calculated, the error term is updated, \hat{β}ⱼ₊₁^{[i]}, and stored [156] . The flow chart branches involved here are [702, 710, 712, 714]; [702, 710, 716, 718]; [702, 720, 722, 724]; and [702, 720, 726, 728].

The calculation of the length of the run of order i in the line, rⱼ^{[i]} is as follows:

If type t^{[i]}=0:

If \hat{β}ⱼ^{[i]}≧0 [710] the run is short [712], rⱼ^{[i]}=rₛ^{[i]}, and \hat{β}ⱼ₊₁^{[i]}=\hat{β}ⱼ^{[i]}−\hat{ν}^{[i]} [714].

If \hat{β}ⱼ^{[i]}<0 [710] the run is long [716], rⱼ^{[i]}=rₗ^{[i]}, and \hat{β}ⱼ₊₁^{[i]}=\hat{β}ⱼ^{[i]}+\hat{μ}^{[i]} [718].

If type t^{[i]}=1:

If \hat{β}ⱼ^{[i]}≧0 [720] the run is long [722], rⱼ^{[i]}=rₗ^{[i]}, and \hat{β}ⱼ₊₁^{[i]}=\hat{β}ⱼ^{[i]}−\hat{ν}^{[i]} [724].

If \hat{β}ⱼ^{[i]}<0 [710] the run is short [712], rⱼ^{[i]}=rₛ^{[i]}, and \hat{β}ⱼ₊₁^{[i]}=\hat{β}ⱼ^{[i]}+\hat{μ}^{[i]} [728].

The values of the structural parameters \hat{μ}^{[i]} and \hat{ν}^{[i]} and the length of a short and long run, rₛ^{[i]} and rₗ^{[i]}, are retrieved [144] from the structure of the hierarchy of runs [140].

Once the length of the run is calculated, the run is set into memory [194] by the Bitmap Processor [106] and [732]. The Run Processor keeps processing runs as just described until it reaches the end of the line segment [730].

Applications of the Line Drawing Techniques

The line drawing techniques described herein can be employed in any application where techniques of the general class to which these techniques belong are useful. The techniques are of course particularly useful in applications where the coordinates of the endpoints of the lines may have real number values, including values that are irrational numbers. Such applications include the following:

Two-Dimensional Polygon Filling and Scan Conversion

Techniques for filling a polygon on a raster or bitmap display often step along the circumference of the polygon and fill or scan convert the polygon along the horizontal runs defining the interior of the polygon (see Lathrop 1990). A problem with using existing line drawing techniques for this purpose is that the endpoints of the line are defined at pixel or sub-pixels positions and using these algorithms to step along the circumference of the polygon can cause dropouts or multiply processed pixels to occur. The line drawing technique described can be used to step along the circumference of the polygon without these errors.

Three-Dimensional Polygon Scan Conversion

When a 3D polygon is being rendered into a 2D image using interpolative techniques such as Gouraud or Phong shading, typically a technique similar to the 2D polygon scan conversion embodiment is used. A technique that is also possible is to shade the polygon using lines of constant depth. Think of a plane parallel to the view plane being used. As the plane is moved backwards through the polygon, the line of intersection between the plane and the polygon can be defined. This line has a constant depth that can be used to make the shading technique more efficient. To shade the polygon you can step along this line using the line drawing technique described setting each pixel the color calculated by the shading algorithm.

Visibility Checking—Computer Games and Simulation

In computer games and simulation a common problem is to determine if two points are visible to one another. If the environment that can occlude the two points can be defined on a 2D grid, the line drawing technique describe can be used to check each of the grid points linearly separating the two points to determine if they are occluded from one another.

Visibility Checking—Mobile Network Planning

In the mobile phone industry one of the greatest problems is in planning the mobile phone base station network to ensure effective coverage. Mistakes in deciding where to place base stations and their power requirements can be very expensive. One common solution is to use two-dimensional ray tracing methods to simulate the working environment of a mobile network. Effectively the environment is modeled in two dimensions and rays are traced through the environment to determine the coverage achieved. If the space around the environment is modeled as a grid, the process for drawing a line can be used to traverse a ray through the grid. The line segment becomes a ray if no endpoint is assumed. As the line is traced through the environment, instead of drawing each pixel in the display bitmap, the grid cell can be checked.

Simulation of Sonar Propagation

In sonar propagation simulation, often laminar sheets of water or other media are traced with rays to determine the propagation of rays through the medium. If the media can be modeled on a discrete grid, the line drawing algorithm can be used to propagate the ray through the medium.

Heightfield Rendering

Ray tracing has long been used to render height fields or elevation maps. The run-based ray line drawing technique can be adapted to traverse a ray over the height field to seek an intersection with an elevation.

Hough Transfer

In line and shape detection problems in which the Hough Transform is used as a voting strategy, the voting process requires a line of votes to be cast into an array. The run-based line digitization techniques described can be used to cast the votes.

Conclusion

The foregoing Detailed Description has disclosed to those skilled in the relevant technologies the inventors' method of making a determination in a lattice of a set of cells of the lattice that are intersected by a line where the coordinates of the line's end points may have any real number value according to a technique that employs orders 1..n of runs of lattice cells and has further disclosed how to use the invention and the best mode presently known to the inventors of making the invention.

It will however be immediately apparent to those skilled in the relevant technologies that other implementations of the techniques of the invention may employ error terms and structural parameters having forms different from the ones disclosed herein. For example, the use of two structural parameters in the preferred embodiment is simply a matter of design choice, since each of the structural parameters can be derived from the other. What is important is thus not the specific forms of the error terms and structural parameters disclosed herein, but rather the relationships between the characteristics of the runs of a particular order and the error term and structural parameters for that order as well as the use of the structural parameters of one order to determine the type of the next order and the use of the error term of one order together with the type to determine the length and error term of a truncated run of the next order. Further, though the examples disclosed herein involve the construction of pixel representations of lines, the techniques may be used in any situation where it is useful to determine what cells of a lattice are intersected by a given line.

Since this is so, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

What is claimed is:

1. A method of beginning a determination in a lattice of a set of cells of the lattice that are intersected by a line, the lattice being represented in memory accessible to a processor and the determination being done by the processor according to a technique that determines runs of cells that are intersected by the line and the method comprising the steps performed by the processor of:
determining whether the starting point of the line is within a cell of the lattice; and
when the starting point is within the cell, including the cell in the set as the first cell of the set and making determinations of further cells belonging to the set according to the determination technique.

2. The method set forth in claim 1 further comprising the step performed when there is an included cell of:
using the position of the line's starting point relative to the left-hand side of the cell and the bottom of the cell and the slope of the line to determine whether a next cell to be included in the set has the same y coordinate as the included cell or the next higher y coordinate for a cell.

3. The method set forth in claim 2 wherein the step of using the position comprises the steps of:
determining the difference X₀^{[0]}=(x₀−x₀^{[0]}) between x₀, the x coordinate of the starting point, and x₀^{[0]}, the x coordinate of the left-hand edge of the first cell;
determining the difference (y₀−y₀^{[0]}) between y₀, the y coordinate of the starting point, and y₀^{[0]}, the y coordinate of the bottom edge of the first cell; and
determining an error term \hat{β}₀^{[0]}=(y₀−y₀^{[0]})τ, where τ is the reciprocal of the slope of the line;
setting \hat{β}₀^{[0]}=\hat{β}₀^{[0]}+1−X₀^{[0]}; and if \hat{β}₀^{[0]}<τ then the next cell is a cell with the same y coordinate as the first; otherwise, they coordinate of the next cell is y+1.

4. The method set forth in claim 1 wherein:
any of the coordinates of the endpoints of the line has an irrational value.

5. The method set forth of claim 1 wherein:
the cells intercepted by the line represent pixels and the method is used to construct a pixel representation of the line in the lattice.

6. The method set forth in claim 5 wherein:
any of the coordinates of the endpoints of the line has an irrational value.

7. A method of making a determination in a lattice of a set of cells of the lattice that are intersected by a line, any of the coordinates of the line's endpoints being an irrational value, the lattice being represented in memory accessible to a processor and the determination being done in the processor according to a technique that employs orders 1 . . . n of runs of lattice cells to make the determination, and the method comprising the steps of:
initializing the determination by
deriving an error term with a real number value and a structural parameter with a real number value for order 1 using the values of the coordinates for the end points and
performing the step beginning with order 2 for each order i, 2≦i≦n of
determining an error term with a real number value and a structural parameter with a real number value for the order i using the error term and structural parameter from order i-1; and thereupon
making the determination for the runs of order n using the error term and structural parameter for order n.

8. The method set forth in claim 7 further comprising the step performed in addition to deriving the error term and structural parameter for any of the orders 1 through n of:
if the first run of the order is truncated,
using the error parameter to determine the cells belonging to the truncated run of the order.

9. The method set forth in claim 7 further comprising the steps of:
after making the determination for each run of order n, using the structural parameter for order n to update the error term for order n.

10. The method set forth in claim 9 wherein:
for a non-truncated run of order n, only the error term for the run of order n need be computed.

11. The method set forth in claim 7 wherein:
the method terminates when the cell that contains the ending coordinates for the line is determined to belong to the set of cells.

12. The method set forth in claim 7 further comprising the steps of:
when the line's starting coordinates are within a cell of the raster, determining from the difference between the starting x coordinate and the x coordinate of the lower left-hand comer of the cell whether the cell is to be included in the set; and
when the cell is to be included, using the method beginning with the next cell to be included to determine what cells are to be included in the set.

13. The method set forth in claim 12 further including the step performed when the cell is to be included of:
determining an error term using the difference between the starting y coordinate and the y coordinate of the lower left-hand comer of the cell and the slope of the line; and
using the error term to determine the next cell to be included.

14. The method set forth in claim 13 wherein:
the error term is the error term for the first run of order 1, the first run of order 1 being either truncated or untruncated.

15. The method set forth in claim 7 wherein: each order of runs i has a type and a shape, with order 1 having a predefined type; and
the method further comprises the steps performed beginning with order 2 for each order i, 2≦i≦n of:
using the structural parameter for order i−1 to determine the type of order i; and
using the type of order i and the type of order i−1 to determine the shape of order i.

16. The method set forth in claim 15 further comprising the step performed beginning with order 2 for each order i, 2≦i≦n of:
using the type of order i to determine the structural parameter for order i.

17. The method set forth in claim 15 further comprising the step performed beginning with order 2 for each order i, 2≦i≦n of:
storing the structural parameter and the type for each order i in storage accessible to the processor.

18. The method set forth in claim 15 wherein:
each order i has a slope α^{[i]}, with α^{[1]} being the slope of the line;
each order i has an average length
$${τ}^{[ i ]} = \frac{1}{{α}^{i}} ,$$
with the length of a short run rₛ^{[i]} of order i being └τⁱ┘ and the length of a long run rₗ^{[i]} of order i being |τ^{[i]|};
there is a first structural parameter \hat{μ}ⁱ and a second structural parameter \hat{ν}^{[i]};
α^{[i]}=min(\hat{μ}ⁱ,\hat{ν}ⁱ);
the type t^{[i]} of order i is either 1 or 0;
when t^{[i]}=0, \hat{ν}^{[i]}=τ^{[i]}−rₛ^{[i]} and \hat{μ}ⁱ=1−\hat{ν}^{[i]} and
when t^{[i]}=1, \hat{μ}ⁱ=τ^{[i]}−rₛ^{[i]} and \hat{ν}^{[i]}=1−\hat{μ}ⁱ;
t^{[i]}=0 when i=1 and otherwise t^{[i]}=0 when \hat{μ}^{[i-1]}≦\hat{ν}ⁱ⁻¹ and otherwise 1;
when the run of order i is not truncated, the error term for run 0 of the order, \hat{β}₀^{[i]} is the same as the error term \hat{β}₀^{[i-1]} for run 0 of order i−1;
when the run of order i is truncated,
when t^{[i]}=0, the length r₀^{[i]} of the truncated run is the integer ceiling of τ^{[i]}(1−\hat{β}₀^{[i-1]}); otherwise the length r₀^{[k]} is the integer ceiling of τ^{[i]}(\hat{β}₀^{[i-1]}); and
when t^{[i]}=0, the error term for the truncated run \hat{β}₀^{[i]}=r₀^{[i]}−τ^{[i]}(1−\hat{β}₀^{[i-1]}) and otherwise \hat{β}₀^{[i]}=r₀^{[i]}−τ^{[i]}\hat{β}₀^{[i-1]}).

19. The method set forth in claim 7 wherein:
the cells intercepted by the line represent pixels and the method is used to construct a pixel representation of the line in the lattice.
